(19) United States
(12) Patent Application Publication
(10) Pub. No.: US 2008/0192741 A1
(43) Pub. Date: Aug. 14, 2008

(54) High Speed Data Processing Communication Method and Apparatus for Embedded System

(76) Inventors: Jung Tae Lee, Busan (KR); Kwang Choo, Gyonggi-do (KR); Yun Young Go, Seoul (KR); Bong Jun Hur, Seoul (KR); June Woo Ryu, Seoul (KR)

Correspondence Address: CHRISTOPHER PAUL MITCHELL, 888 16TH ST., NW, SUITE 800, WASHINGTON, DC, 20006, US

(21) Appl. No.: 11/914,130

(22) PCT Filed: Apr. 25, 2006
(86) PCT No.: PCT/KR06/01552

§ 371 Date: Nov. 9, 2007

(30) Foreign Application Priority Data
May 11, 2005 (KR) 10-2005-0039168

(51) Int. Cl. H04L 12/56

(52) U.S. Cl. 370/389

(57) ABSTRACT

The present invention relates to a communication apparatus with a high-speed data processing function for an embedded system, and an apparatus thereof. A MAC process communication apparatus comprises hardware TCP/IP processing and socket decision means. Upon transmission of data, if data to be transmitted are previously set hardware processing data, an application interface unit transfers the data directly to the hardware TCP/IP processing means without through the OS and the hardware TCP/IP processing means process a TCP/IP protocol of the transmission data, and if the data to be transmitted are not the hardware processing data, but are general data, the OS processes the TCP/IP protocol in a software manner. Upon reception of data, if the socket decision means determines that received data are the previously set hardware processing data, the hardware TCP/IP processing means directly processes a TCP/IP protocol and directly interfaces the received data to the application, and if the socket decision means determines that the received data are not data of a hardware processing port number, the OS is interfaced to process a software TCP/IP protocol.

### TECHNICAL FIELD

The present invention generally relates to a communication apparatus with a high-speed data processing function for an embedded system, and more particularly, to a communication apparatus with a high-speed communication function by employing a high-speed hardware socket that processes a communication protocol in a hardware manner unlike an existing communication apparatus in which Internet communication is performed through the embedded system.

### BACKGROUND ART

In general, a communication apparatus for Internet communication performs communication using a common MAC chip and a software TCP/IP that is installed at the OS.

FIG. 1 is an explanatory view illustrating the network communication apparatus employing the software TCP/IP method in the related art.

As shown in FIG. 1, the communication apparatus includes a communication apparatus 20 connected to a physical layer 10 through a MII interface, and an OS layer 30 connected to the communication apparatus 20 through a host interface. The communication apparatus 20 is also referred to as a “MAC chip”. Software TCP/IP for communication control of system is mounted in the OS layer 30. The OS layer 30 is connected to an application layer through a socket interface and performs a communication.

FIG. 1 illustrates data transmission. If an application transmits ‘data’ to the OS layer 30 through he socket interface for data transmission, the software TCP/IP of the OS layer 30 generates ‘IP header’ and ‘TCP header’ based on an IP protocol and a TCP protocol, joins the generated ‘IP header’ and ‘TCP header’ to ‘data’, and transmits the data packet to the communication apparatus 20 through the host interface.

The communication apparatus 20 further joins the physical header to the data packet, generates a transmission data packet that is joined as ‘physical header+IP header+TCP header+data’, and transmits the generated transmission data packet to the physical layer 10 through the MII interface. The physical layer 10 transmits the data packet over the Internet.

In contrast, upon reception of data, the communication apparatus 20 receives a network data packet consisting of ‘physical header+IP header+TCP header+data’ from the physical layer 10 and separates the ‘physical header’. The software TCP/IP of the OS layer 30 separates the ‘IP header’ and the ‘TCP header’ based on an IP protocol and a TCP protocol and transmits only the ‘data’ to the application through a socket interface.

In the network communication apparatus employing the software TCP/IP method in the related art, however, the communication apparatus 20 (i.e., the MAC chip) serves to only add or separate only the physical header to or from the input network packet data and simply transmit the remaining data packet. Therefore, the processing of the communication protocol, which is inevitable for communications through the network, is handled by the host system (i.e., the OS layer 30).

In the embedded system, the resources of the host system are very limited unlike the existing PC system. Accordingly, the processing of the communication protocol imposes a heavy burden on the system, thereby being problematic in performing other applications and also significantly reducing the communication speed.

Accordingly, there is a need for a communication apparatus for an embedded system requiring a high-speed data processing, which can solve the system load problem and the communication speed problem due to increased multimedia applications.

In the case where the MAC chip is employed and software TCP/IP of the OS processes the communication protocols as shown in FIG. 1, there are advantages in that the software TCP/IP is included in the OS, the protocol can be easily modified, and additional hardware is not required.

However, there are disadvantages in that OS which includes software TCP/IP is necessarily required, the processing capability of the processor for OS and application is required, and the protocol processing speed could be limited.

Meanwhile, hardware TCP/IP in which TCP/IP is implemented in hardware and is integrated with the MAC chip has been proposed in order to overcome the disadvantages of the software TCP/IP. For example, the present application proposed Korean Patent Application No. 2002-19062 entitled “INTERNET PROTOCOL COMMUNICATION APPARATUS IMPLEMENTED USING HARDWARE PROTOCOL PROCESSING LOGIC AND DATA PARALLEL PROCESSING METHOD USING THE COMMUNICATION APPARATUS”.

FIG. 2 is an explanatory view illustrating a network communication apparatus employing a hardware TCP/IP method in the related art.

As shown in FIG. 2, the hardware TCP/IP communication apparatus 40 has a MAC chip and a TCP/IP processing unit implemented using hardware, is connected to a physical layer 10 through a MII interface, and the hardware TCP/IP communication apparatus 40 is connected to a host interface. Furthermore, the hardware TCP/IP communication apparatus 40 is directly connected to an application layer of the system. The hardware TCP/IP communication apparatus 40 performs a communication process while directly exchanging data with the application.

FIG. 2 illustrates data transmission. If the application directly transmits ‘data’ to the hardware TCP/IP communication apparatus 40 in order to transmit the data, the hardware TCP/IP communication apparatus 40 generates a ‘physical header’, an ‘IP header’, and a ‘TCP header’ in real-time through the MAC process, the IP protocol, and the TCP protocol, and joins the generated them to the ‘data’. If the hardware TCP/IP communication apparatus 40 transmits the data packet in which ‘physical header+IP header+TCP header+data’ are joined to the physical layer 10 through the MII interface, the physical layer 10 transmits the data packet over the Internet.

In contrast, upon reception of the data, if the physical layer 10 transmits a network data packet consisting of ‘physical header+IP header+TCP header+data’ to the hardware TCP/IP communication apparatus 40, the MAC processing unit separates the ‘physical header.’ The hardware TCP/IP communication apparatus 40 separates the ‘IP header’ and the ‘TCP header’ in real-time based on an IP protocol and a TCP protocol and directly transmits only ‘data’ to the application.

Therefore, the hardware TCP/IP communication apparatus does not require a communication protocol process of the OS since it processes the TCP/IP protocol in hardware. Accordingly, there is no need for a CPU with strong processing capability or a lot of system resources.

The hardware TCP/IP communication apparatus is also advantageous in that it can be easily applied to existing apparatuses, can have the highest performance in a system with limited resources by real-time protocol processing, and can be easily applied to relatively simple embedded systems.

However, the hardware TCP/IP communication apparatus is disadvantageous in that it cannot be modified simultaneously with a change in the protocol and it's hard to reflect new requirements.

### DISCLOSURE

### [Technical Problem]

Accordingly, the present invention has been made in view of the above problems occurring in the prior art network communication apparatus, and it is an object of the present invention to provide a communication method having a high-speed data processing function for an embedded system, and apparatus thereof, in which the embedded system with a limited resource can have a high-speed data processing function and can reflect new requirements immediately so that a protocol process that must be processed in a host system can be processed by hardware.

### [Technical Solution]

In accordance with the present invention, high-speed and mass data, such as multimedia, are communicated through a dedicated hardware socket, and general data are communicated through a software TCP/IP protocol of a host system.

Furthermore, in accordance with the present invention, a protocol is processed in real-time through hardware and only real data are transmitted to the host. Accordingly, the embedded system can have a performance close to the maximum bandwidth of the physical layer and can have a high-speed data transmission/reception function.

Furthermore, the present invention can provide the scalability and flexibility that can immediately reflect new requirements or a change in the protocol through a dual path in which both the hardware socket employing hardware TCP/IP and the software socket employing software TCP/IP of an OS can be used.

In accordance with the present invention, a MAC communication apparatus include a hardware TCP/IP processing unit and a socket decision unit. The data communication path is made dual so that data requiring the high-capacity and high-speed process are processed directly through the hardware TCP/IP processing unit and general data are processed in the software TCP/IP of the OS.

In accordance with the present invention, it is automatically determined whether data are data to be processed through hardware TCP/IP or data to be processed through software TCP/IP using a port number of a TCP protocol header, which is used as an identifier to identify data with respect to an application.

### BRIEF DESCRIPTION OF THE DRAWINGS

FIG. 1 is an explanatory view illustrating the network communication apparatus employing the software TCP/IP method in the related art.

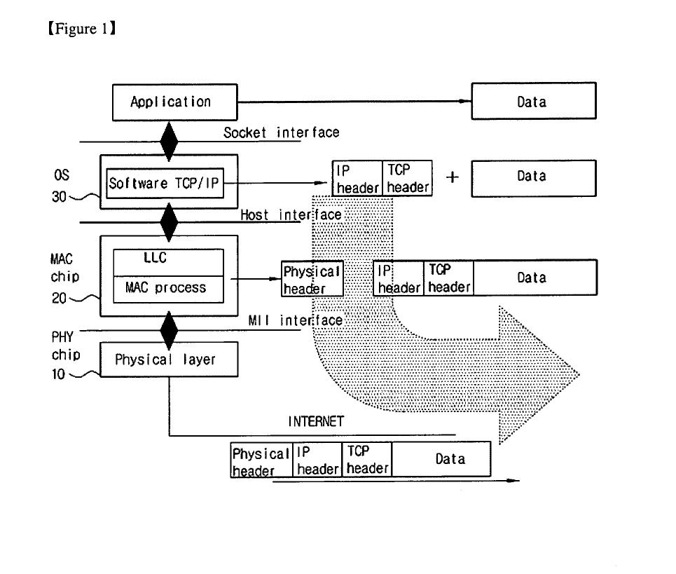

FIG. 2 is an explanatory view illustrating the network communication apparatus employing the hardware TCP/IP method in the related art.

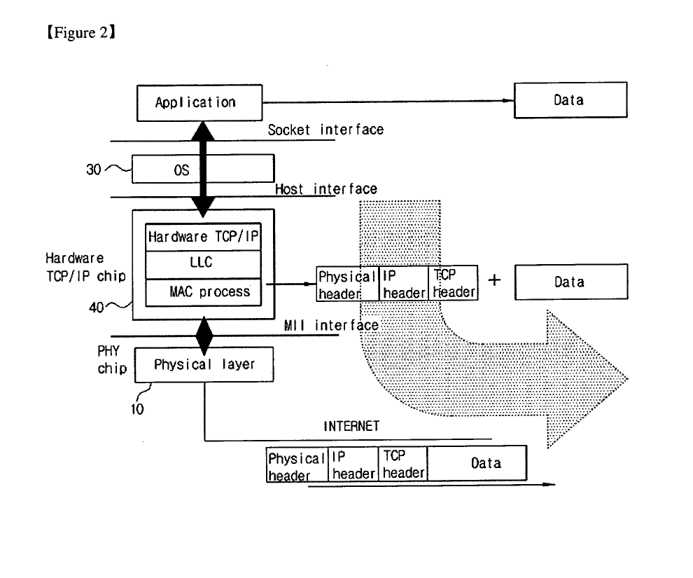

FIG. 3 is a conceptual view of a communication apparatus illustrating a communication method with a high-speed data processing function for an embedded system according to the present invention.

FIG. 4 is a block diagram of a communication apparatus having a high-speed data processing function for an embedded system according to the present invention.

FIG. 5 is a block diagram of a hardware socket processing unit according to the present invention.

FIG. 6 is an explanatory view illustrating the configuration of a TCP packet header of a general data packet.

FIGS. 7a and 7b are explanatory views illustrating a communication application between the server and the PC, for describing the present invention.

### BEST MODE

According to the present invention, there is provided a communication method using a MAC process communication apparatus connected to an OS in which software TCP/IP is mounted through a host interface, the MAC process communication apparatus performing a communication process and comprising hardware TCP/IP processing means and socket decision means, the communication method including the steps of:

upon transmission of data, if data to be transmitted are previously set hardware processing data, allowing an application interface unit to transfer the transmission data directly to the hardware TCP/IP processing means without through the OS and allowing the hardware TCP/IP processing means to process a TCP/IP protocol of the transmission data, and if the data to be transmitted are not the hardware processing data but are general data, allowing the OS to process the TCP/IP protocol of the transmission data in a software manner, and

upon reception of data, if the socket decision means determines that received data are previously set hardware processing data, allowing the hardware TCP/IP processing means to directly process a TCP/IP protocol of the received data and to directly interface the received data to an application, and if the socket decision means determines that the received data are not data of a port number for a hardware processing, allowing the OS to process the TCP/IP protocol of the received data in a software manner.

The determination of whether the data are hardware processing data or software processing data is performed using a hardware process on a given port number of a TCP header. If the data are not the port number of the hardware processing data, the data are determined to be general data and a data communication path is set according to a software process.

A communication apparatus having a high-speed data processing function for an embedded system according to the present invention includes a physical medium interface processing unit that interfaces data with a physical layer; a transmission data processing unit that transfers data to be transmitted from a link layer to the physical medium interface processing unit; a reception data processing unit that receives received data from the physical medium interface processing unit and transfers the received data to an upper layer; a reception memory that stores the received data received from the reception data processing module and transfers the stored data to an upper interface according to instructions of a hardware socket processing unit and a register controller; a transmission memory that stores the data to be transmitted, which are received from the upper interface and transmits the stored data to the hardware socket processing unit and the transmission data processing unit according to an instruction of the register controller; a hardware socket processing unit that determines whether the transmitted data and the received data are packet data requiring high-speed communication through a high-speed hardware socket and processes a TCP protocol and an IP protocol according to the determination result; a register controller that controls an overall operation of a register that manages information about the operation of the communication apparatus and the communication apparatus accordingly; and an upper interface processing unit that transmits and receives data to and from a host system.

The hardware socket processing unit includes an IP protocol processing unit that processes a protocol corresponding to an IP layer in a hardware manner so that high-speed communication is made possible; a TCP protocol processing unit that processes a protocol corresponding to a TCP layer in a hardware manner so that high-speed communication is made possible; and a socket decision unit that identifies a port number from a TCP header of data that are transmitted or received, and determines whether a corresponding data socket is a data packet for high-speed data through a hardware socket or a data packet for general communication so that the hardware TCP/IP processing unit is controlled according to the determination result.

The communication apparatus further include an application interface unit that causes high-speed and mass data whose port number is designated in the application to be directly interfaced with the upper interface processing unit and causes general data other than the designated port number to be interfaced with the OS layer, upon transmission of data.

The present invention will now be described in detail in connection with specific embodiments with reference to the accompanying drawings.

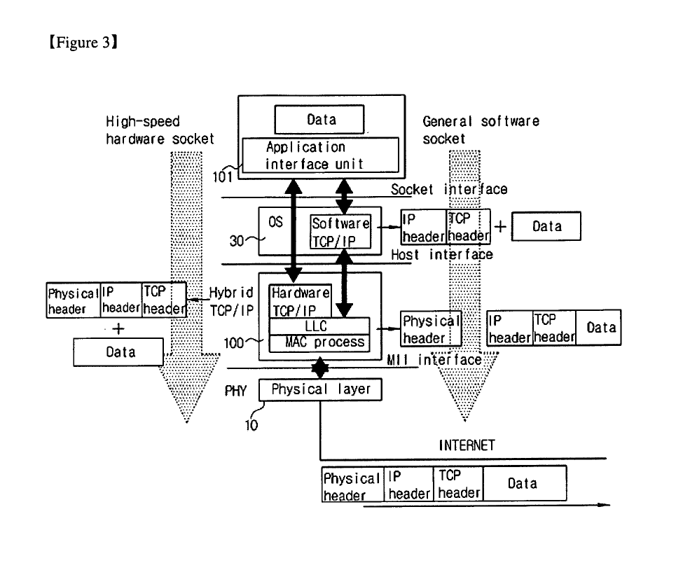

FIG. 3 is a conceptual view of a communication apparatus illustrating a communication method with a high-speed data processing function for an embedded system according to the present invention.

As shown in FIG. 3, the communication apparatus includes a physical layer 10 connected to the Internet, a hardware TCP/IP communication apparatus 100 connected to the physical layer 10 through a MII interface, an OS layer 30 connected to the hardware TCP/IP communication apparatus 100 through a host interface, and an application layer connected to the OS layer 30 through a socket interface. The hardware TCP/IP communication apparatus 100 includes a MAC processing unit, a LLC, hardware TCP/IP processing means, and socket decision means. The OS layer 30 has software TCP/IP mounted therein. The application layer includes an application interface unit 101.

In the communication method of the present invention, highspeed and mass data are directly communicated between the application layer and the hardware TCP/IP communication apparatus according to a hardware TCP/IP protocol process. General data are communicated according to a software TCP/IP protocol process of the OS layer.

To this end, the application interface unit 101 determines a port number of data to be transmitted when transmitting the data. If the data are previously set hardware processing data as a result of the determination, the application interface unit 101 directly transmits the transmission data to the hardware TCP/IP communication apparatus 100 without through the OS layer 30.

If it is determined that the port number of the data to be transmitted are general data not the hardware processing data port number, the application interface unit 101 provides a user application with an interface through which the transmission data are transmitted to the OS layer 30 so that the OS layer 30 can process a TCP/IP protocol according to a software method.

Furthermore, the socket decision unit of the hardware TCP/IP communication apparatus 100 determines the port number of data received from the physical layer 10. If it is determined that the received data are hardware processing data of the previously set port number, the hardware TCP/IP processing means directly processes a TCP/IP protocol and directly interfaces the received data to the application.

If it is determined that the received data are not the hardware processing data of the previously set port number, the socket decision unit is constructed so that the OS processes the software TCP/IP protocol.

As described above, according to the present invention, as shown in FIG. 3, high-speed hardware sockets (i.e., high-speed and mass data such as motion pictures and graphics) experience the hardware TCP/IP process and the MAC process. General software sockets experience the software TCP/IP process in the OS layer and then experience the MAC process. Accordingly, the data communication path becomes a dual path.

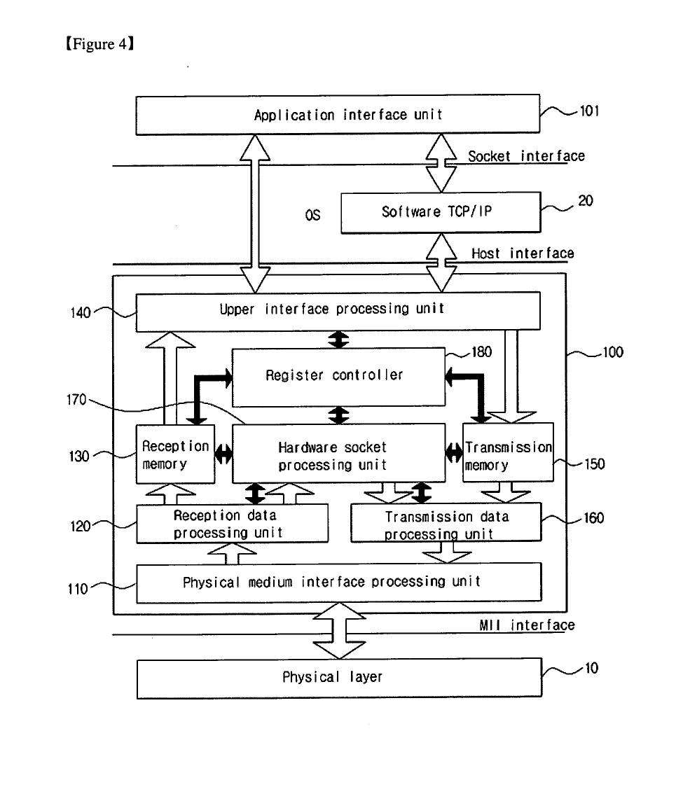

FIG. 4 is a block diagram of the communication apparatus having the high-speed data processing function for the embedded system according to the present invention.

As shown in FIG. 4, the communication apparatus includes a physical medium interface processing unit 110 that interfaces data with a physical layer 10, a transmission data processing unit 160 that transfers data to be transmitted from a link layer to the physical medium interface processing unit 110, a reception data processing unit 120 that transfers data, which are received from the physical medium interface processing unit 110 to an upper layer, a reception memory 130 that stores data from a reception data processing unit and transfers the received data to an upper interface according to instructions from a hardware socket processing unit 170 and a register controller 180, a transmission memory 150 that stores data to be transmitted, which are received from the upper interface, and transmits the data to the hardware socket processing unit 170 and the transmission data processing unit 160 according to an instruction from the register controller 180, the hardware socket processing unit 170 that determines whether the transmitted and received data are packet data requiring high-speed communication through the high-speed hardware socket and processes a TCP protocol and an IP protocol according to the determination result, the register controller 180 that controls an overall operation of a register that manages information about the operation of the communication apparatus and the communication apparatus accordingly, and an upper interface processing unit 140 that transmits and receives data to and from a host system.

The communication apparatus further includes an OS layer 30 and an application interface unit 101 of the application layer. The OS layer 30 is connected to the upper interface processing unit 140 through a host interface and has a software TCP/IP processing program mounted therein. The application interface unit 101 interfaces general data, which experience the software TCP/IP process, with the OS layer 30, and interfaces data, which experience the hardware TCP/IP protocol process, with the upper interface processing unit 140.

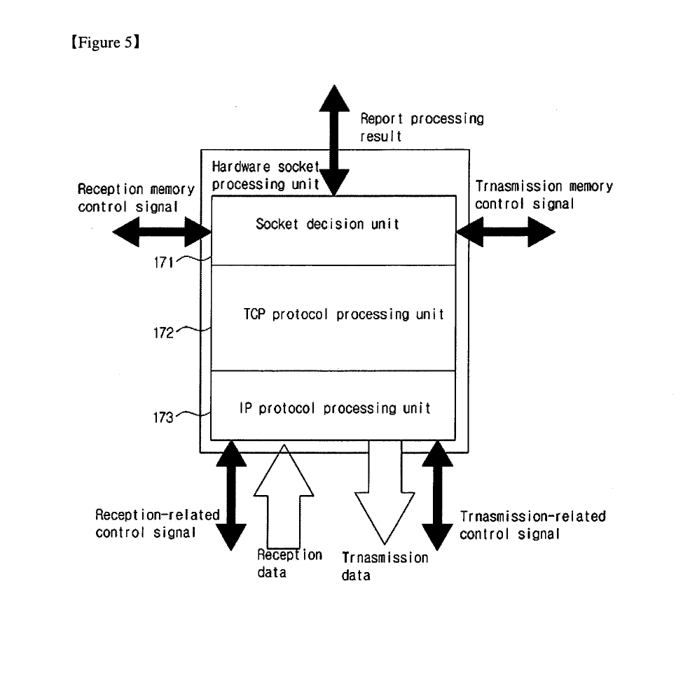

FIG. 5 is a block diagram of the hardware socket processing unit according to the present invention.

As shown in FIG. 5, the hardware socket processing unit 170 includes an IP protocol processing unit 173, a TCP protocol processing unit 172, and a socket decision unit 171. The IP protocol processing unit 173 processes a protocol corresponding to an IP layer in a hardware manner so that high-speed communication is possible. The TCP protocol processing unit 172 processes a protocol corresponding to the TCP layer in a hardware manner so that high-speed communication is possible.

The socket decision unit 171 identifies a port number from a TCP header of data that are transmitted and received, determines whether a corresponding data socket is a data packet for processing high-speed data through the hardware socket or a data packet for general communication, and controls the hardware TCP/IP processing unit according to the determination result.

In the communication apparatus constructed above according to the present invention, the hardware TCP/IP processing unit and the socket decision unit are integrally formed with the MAC chip in an Internet communication method in which the existing MAC chip and the software TCP/IP program of the OS are mounted. Accordingly, data communication can be performed through a dual path in such a manner that the hardware TCP/IP protocol process is performed on high-speed and mass data, such as motion pictures, and the software TCP/IP protocol process is performed on general data.

The determination of whether data are data on which the hardware TCP/IP process will be performed or data on which the software TCP/IP process will be performed is determined based on a port number, and a data communication path is controlled according to the determination result.

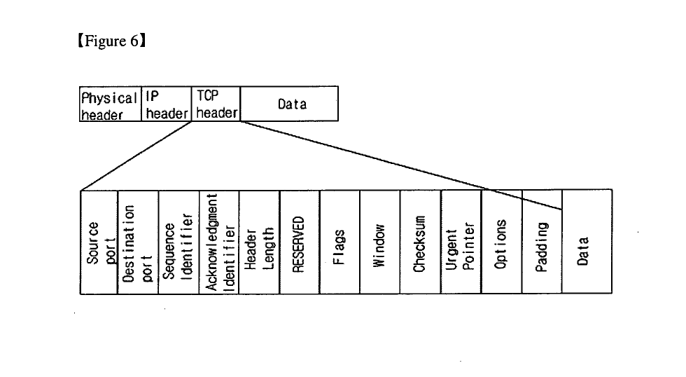

FIG. 6 is an explanatory view illustrating the configuration of a TCP packet header of a general data packet.

A source port of the TCP packet header denotes a 16-bit port number of an application that transmits data and a destination port of the TCP packet header denotes a 16-bit port number of an application that will receive data. Therefore, in the present invention, the numbers of the source port and the destination port are used to determined whether it is the hardware TCP/IP process or the software TCP/IP process.

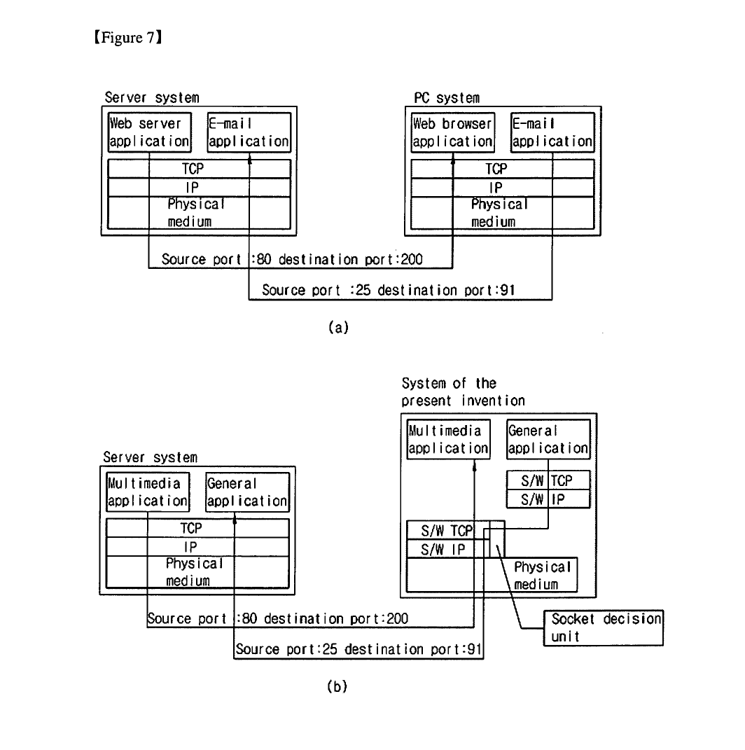

FIGS. 7a and 7b are explanatory views illustrating a communication application between a server and a PC, for describing the present invention.

If the server and the PC perform communications through the Internet, thousands of severs and PCs on the Internet are identified according to their IP addresses. In one system (for example, PC or server), several applications are connected through the Internet. At this time, a port number is used to designate their connection on an application basis.

In a situation as shown in FIG. 7a, two kinds of application perform communication using the Internet at the same time in the server and the PC. Accordingly, there is a need for an identifier to identify data with respect to each application. A port number of a TCP protocol header is used at this time.

Therefore, in the present invention, all data are analyzed up to the TCP port number in real-time as shown in FIG. 7b. The socket decision unit determines whether data are data on which the high-speed data process through hardware TCP/IP will be performed or socket data using general software TCP/IP based on the analysis data in real-time.

The data transmission process of the present invention will be described below.

An application of a transmission system transmits a transmission instruction to the application interface 101 along with data. The application interface 101 transfers the transmission data to the upper interface processing unit 140 of the communication apparatus of the present invention along with the transmission instruction if the transmission data are data which will use the hardware TCP/IP at the request of a user.

The transmission instruction is used to control each module of the communication apparatus in the register controller 180 so that the transmission operation begins. Necessary data are stored in the control register. Main data are stored in the transmission memory 150 through the upper interface 140. The hardware socket processing unit 170 generates a header in real-time and begins transmitting the header through the transmission data processing unit 160.

If the header is transmitted, up to corresponding data of the transmission memory 150 are transmitted to the transmission data processing unit 170 according to an instruction of the controller. The packet is transferred to the Internet through the physical medium interface processing unit 110. After the whole operation is completed, the hardware socket processing unit 170 informs the register controller 150 of the fact. The CPU is informed of the fact through the upper interface 140.

In the case of data which will use the software TCP/IP, data to be transmitted are analyzed using the software TCP/IP in the OS layer 30 in order to generate a packet header. If the process is completed, the data are transmitted to the transmission memory 150 through the upper interface processing unit 140. A transmission instruction including information about the transmission is transmitted to the register controller 180 through the upper interface processing unit 140.

The register controller 180 transmits the data, which are transmitted to the transmission memory 150, to the physical medium interface processing unit 110 through the transmission data processing unit 160 according to the instruction. The physical medium interface 110 transmits the data to the physical layer.

A data reception process will be described below.

Data are received through the physical medium interface processing unit 110. The data are stored in the reception memory 130 through the reception data processing unit 120 and protocol header information is also transmitted to the hardware socket processing unit 170 in order to analyze the received packet data.

A port number is determined through a real-time process with respect to the TCP/IP protocol. The analysis information is compared with an information value stored in the register of the register controller 180 to determine whether the packet will be performed using the hardware TCP/IP or using the software TCP/IP.

If it is determined that the packet will be performed using the hardware TCP/IP, the remaining TCP/IP headers are all analyzed. The analysis results are transmitted to the upper interface processing unit 140 through the register controller 180. The results are transmitted to the CPU again in order to inform that there exist received data. Pure data parts are transmitted to the application interface unit 101 through the reception memory 130 to the upper interface processing unit 140.

If it is determined that the packet will be performed using the software TCP/IP, packet information input to the reception memory 130 is transferred through the software TCP/IP of the OS layer 30 through the upper interface processing unit 140 according to an instruction of the register controller 180. Data transferred through the software TCP/IP experience a process for TCP/IP of an OS and are then transferred to the application interface unit 101.

Therefore, in accordance with the present invention, data requiring a high-speed and high-capacity process are processed through the hardware TCP/IP process and general data are processed through the software TCP/IP process, thereby allowing for efficient data communication.

### INDUSTRIAL APPLICABILITY

As described above, in accordance with the communication apparatus having the high-speed data processing function for the embedded system according to the present invention, the embedded system selectively uses a high-speed data processing function and can perform high-speed communication without load on the CPU. It is therefore possible to provide a variety of high-speed network-based services, such as multimedia service, in the embedded system.

Furthermore, the burden of the CPU of the embedded system to process a communication protocol is reduced. More services can be provided within a limited resource of the embedded system.

In addition, the present invention is advantageous in that it can provide the scalability and flexibility that can immediately cope with new requirements or a change in the protocol through a dual path in which both the hardware socket employing hardware TCP/IP and the software socket employing software TCP/IP of an OS can be used.

1. A communication method using a MAC process communication apparatus connected to an OS in which software TCP/IP is mounted through a host interface, the MAC process communication apparatus performing a communication process and comprising hardware TCP/IP processing means and socket decision means, the communication method comprising the steps of:
upon transmission of data, if data to be transmitted are previously set hardware processing data, allowing an application interface unit to transfer the transmission data directly to the hardware TCP/IP processing means without through the OS and allowing the hardware TCP/IP processing means to process a TCP/IP protocol of the transmission data, and if the data to be transmitted are not the hardware processing data but are general data, allowing the OS to process the TCP/IP protocol of the transmission data in a software manner, and
upon reception of data, if the socket decision means determines that received data are the previously set hardware processing data, allowing the hardware TCP/IP processing means to directly process a TCP/IP protocol of the received data and to directly interface the received data to an application, and if the socket decision means determines that the received data are not data of a port number for a hardware processing, allowing the OS to process the TCP/IP protocol of the received data in a software manner.

2. The communication method as claimed in claim 1, wherein whether the transmitted and received data are the hardware processing data or the software processing data is determined depending on whether the transmitted and received data are a hardware TCP/IP process or a software TCP/IP process based on numbers of a source port and a destination port of a TCP layer protocol packet header.

3. A communication apparatus having a high-speed data processing function for an embedded system, the apparatus comprising:
a physical medium interface processing unit that interfaces data with a physical layer;
a transmission data processing unit that transfers data to be transmitted from a link layer to the physical medium interface processing unit;
a reception data processing unit that receives received data from the physical medium interface processing unit and transfers the received data to an upper layer;
a reception memory that stores the received data received from the reception data processing module and transfers the stored data to an upper interface according to instructions of a hardware socket processing unit and a register controller;
a transmission memory that stores the data to be transmitted, which are received from the upper interface and transmits the stored data to the hardware socket processing unit and the transmission data processing unit according to an instruction of the register controller;
a hardware socket processing unit that determines whether the transmitted data and the received data are packet data requiring high-speed communication through a high-speed hardware socket and processes a TCP layer protocol and an IP layer protocol according to the determination result;
a register controller that controls an overall operation of a register that manages information about the operation of the communication apparatus and the communication apparatus accordingly; and
an upper interface processing unit that transmits and receives data to and from a host system.

4. The communication apparatus as claimed in claim 3, wherein the hardware socket processing unit comprises:
an IP protocol processing unit that processes a protocol corresponding to an IP layer in a hardware manner so that high-speed communication is made possible;
a TCP protocol processing unit that processes a protocol corresponding to a TCP layer in a hardware manner so that high-speed communication is made possible; and
a socket decision unit that identifies a port number from a TCP header of data that are transmitted and received, and determines whether a corresponding data socket is a data packet for high-speed data through a hardware socket or a data packet for general communication so that the hardware TCP/IP processing unit is controlled according to the determination result.

5. The communication apparatus as claimed in claim 3, further comprising an application interface unit that causes high-speed and large-capacity data whose port number is designated in the application to be directly interfaced with the upper interface processing unit and causes general data other than the designated port number to be interfaced with the OS layer, upon transmission of data.

6. A communication method using a MAC process communication apparatus connected to an OS in which software TCP/IP is mounted through a host interface, the MAC process communication apparatus performing a communication process and comprising hardware TCP/IP processor and socket decider, the communication method comprising the operations of:
upon transmission of data, if data to be transmitted are previously set hardware processing data, allowing an application interface unit to transfer the transmission data directly to the hardware TCP/IP processor without processing through the OS and allowing the hardware TCP/IP processor to process a TCP/IP protocol of the transmission data, and if the data to be transmitted are not the hardware processing data but are general data, allowing the OS to process the TCP/IP protocol of the transmission data in a software manner, and
upon reception of data, if the socket decider determines that received data are the previously set hardware processing data, allowing the hardware TCP/IP processor to directly process a TCP/IP protocol of the received data and to directly interface the received data to an application, and if the socket decider determines that the received data are not data of a port number for a hardware processing, allowing the OS to process the TCP/IP protocol of the received data in a software manner.

7. The communication method as claimed in claim 6, wherein the determinations of whether the data to be transmitted and whether the received data are the hardware processing data or the software processing data are determined depending on whether the data to be transmitted and the received data are a hardware TCP/IP process or a software TCP/IP process based on numbers of a source port and a destination port of a TCP layer protocol packet header.
